(19) United States
(12) Patent Application Publication
(10) Pub. No.: US 2005/0106542 A1
(43) Pub. Date: May 19, 2005

(54) Method of training children to avoid dangerous situations and child safety course associated therewith

(76) Inventor: Thomas J. Patire, Elmwood Park, NJ (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/713,766

(22) Filed: Nov. 17, 2003

(51) Int. Cl. G09B 19/00

(52) U.S. Cl. 434/236

(57) ABSTRACT

Child safety training includes a CD having sound segments at spaced intervals thereon, wherein each sound segment is indicative of a hazardous condition such as, but not limited to, a braking car, an approaching train, a barking dog, and/or any other sound which is associated with a dangerous situation. Groups of children are taught to recognize and identify the sounds indicating danger and are then required to run an obstacle course while the CD is being played. The segments are spaced to give the children a chance to run the course. When a segment is played, the children are trained to stop running and how to specifically respond to a danger by moving away from the danger in a particular way and scanning the area in order to further understand the danger.

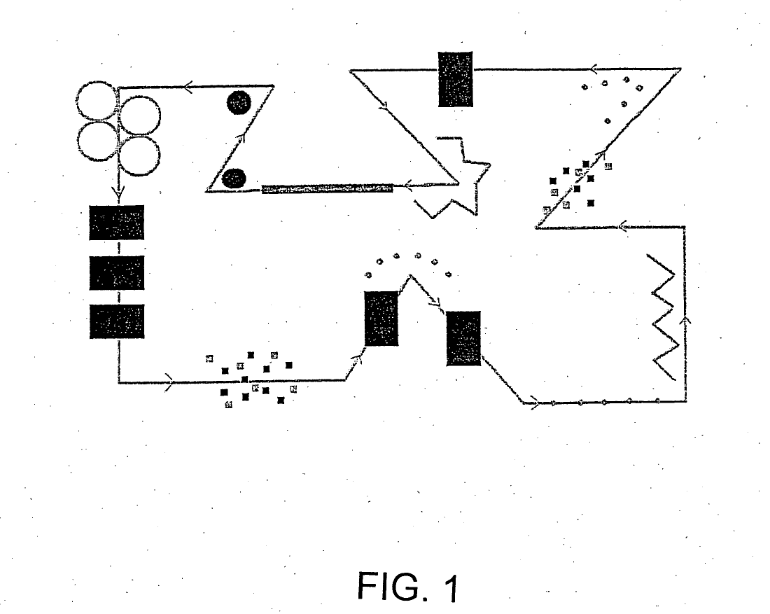

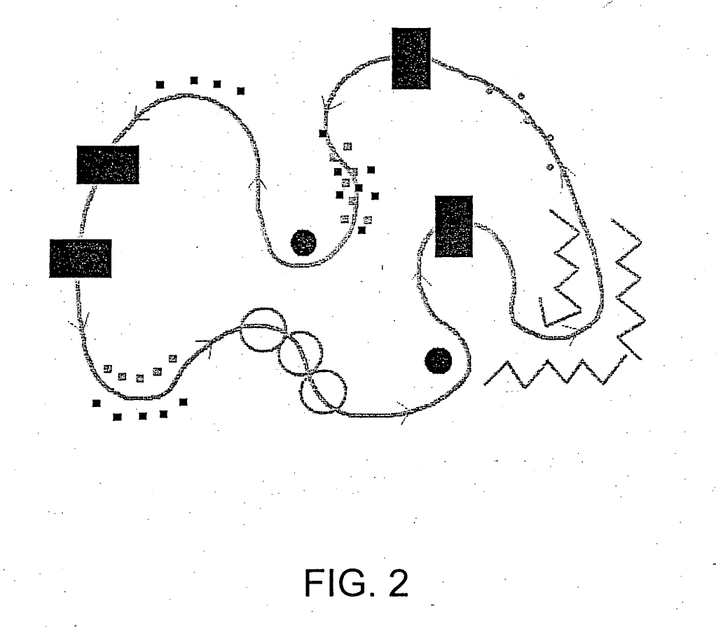

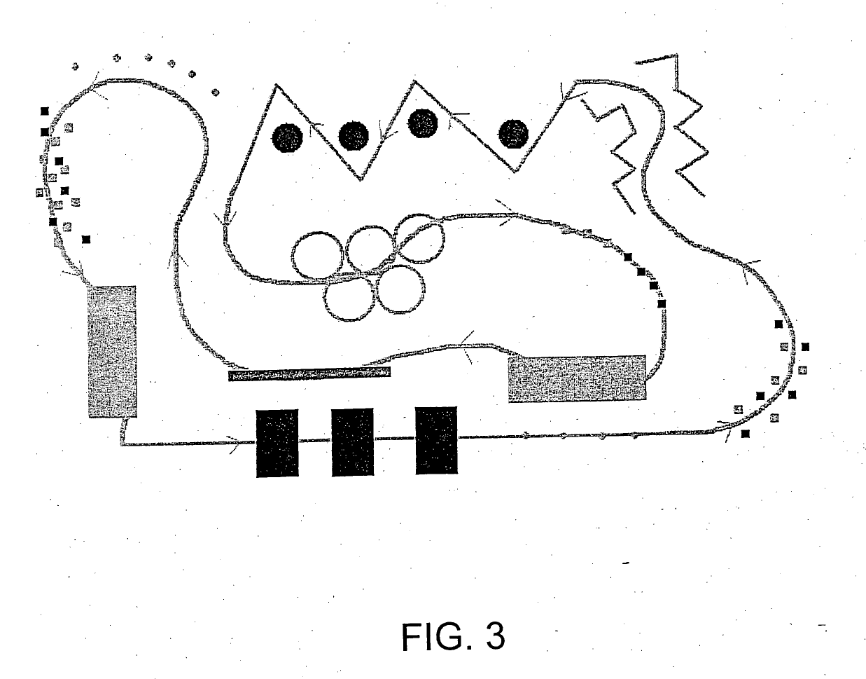

### STEP 1—SPREAD THE WORD

Get the word out about the KNOW & GO™ Child Safety Course. Do this by making a flyer or downloading the advertisement on the secured section of the CDT website. Make sure after you download the material that you print the date, time, place, fee and age group of your course on the advertisement. (Should you want suggestions about designing your own flyer then call us directly at CDT and we will gladly help you.) Once the ad is done hype up the course by talking about it at every class. Make sure you post the ad in highly visible areas and make sure you give a sign-up sheet to all parents. Most of all, constantly play the KNOW & GO™ promo video for all to see.

### STEP 2—REGISTRATION

Once all sign-ups are in, fax a typed list of the children's names only to CDT Training Inc. the way the parents want them printed on the KNOW & GO™ Safety Certificate. Please try to send the names to CDT Training Inc. at least 7 days in advance for processing. This way all of the children's certificates will be processed together and sent to you in time for the course. Remember this is all about the children so we don't want to disappoint them in anyway AND ALL WE NEED IS THEIR NAMES—NOTHING ELSE.

### STEP 3—SOUND IDENTIFICATION

Teach the children sound identification by playing the KNOW & GO™ CD that is enclosed in this Instructors package. Teach them to identify each sound. Do this by playing Track 1—entitled “Sound identification.” The sound track is listed below the way it is on the CD. There is a minimum of a 5 second sound interval between each new sound, with a total of 8 different sounds.

### *TRACK 1—“SOUND IDENTIFICATION”

Time segment—5 Seconds To Name The Correct Sound After The Sound Is Played
START—Bell Rings—Explain That The Bell Has NO Meaning Except To Start The Obstacle Course!!
Broken Glass
Car Screeching To A Halt
Panic Stricken Crowd
Vicious Dog Barking
Police/Fire Vehicles in Motion
Smoke Detector Alarm
Train in Motion
Friendly Voice Asking For Help

### STEP 4—SOUND IDENTIFICATION WITH SAFE MOVEMENT

Play the sounds on the CD and have the children play “follow the leader,” identifying the sounds as they follow ‘you’ the Instructor demonstrating the safe proper movement that is designed for each potentially dangerous sound. Do this by playing Track 2—entitled “Sound-Movement.” There is a minimum of a 10 second interval for naming each of the sounds while showing each safe movement.

### TRACK 2—“SOUND-MOVEMENT”

Time Segment—10 Second Intervals For Naming The Sound And Having The Instructor Show The Safe Proper Movement That Corresponds To Each Sound.
START—BELL RINGS
   Broken Glass

KNOW—Broken Class Can Cause Serious Injuries By Walking On It Or Grabbing It.

GO—Stop, Freeze and Scan.

Car Screeching To A Halt

KNOW—Motor Vehicle Drivers Sometimes Accidentally Lose Control Of Their Vehicles Or Don't Pay Attention To The Road, Just Like Children That Run Into The Street Without Looking.

GO—Quick Stop, Jump Back Turn And Run 5 Steps Then Stop And Scan.

Panic Stricken Crowd

KNOW—Crowds Like At Different Sporting Events Or Amusement Parks Are In Such A Rush To Get In Or Leave Accidentally Trample Children Because They Don't See Them In Time To Stop.

NO—Locate The Nearest Obstacle Or Parent, Grab On To It. If Alone Yell, “Help, Help “Child Here” To Get People To Notice You.

Vicious Dog Barking

KNOW—In Many Cases Dogs Bite Because Of Quick Motions That Startle Or Agitate Them.

GO—Immediate Stop And Remain Motionless.

Police/Fire Vehicles In Motion

KNOW—When A Emergency Vehicle Is In Route To Aid Someone Many Times They Use Excessive Speeds Which Makes The Vehicle Harder To Stop And Sometimes Harder To Control. Children Curiosity Of Where These Vehicles Are Going Or Intrigue Of Seeing The Flashing Lights Can Cause The Child To Run Out In The Street Or Stay To Close To The Curb To Watch.

GO—Immediate Stop, Turn And Run Back At Least 5 Steps And Then Turn And Look.

Smoke Detector Alarm

KNOW—Smoke Inhalation Disrupts Vision And Breathing Leading To Immediate Panic, Especially By A Child.

GO—Crawl Along The Nearest Fixed Object Like A Wall And Yell, “Mommy, Daddy I am In The Room Next To The Wall.”

Train In Motion

KNOW—Train Sounds Echo. In Certain Situations The Noise Sounds Further Than It Really Is Giving A Child A False Sense Of Standing On Or Near The Tracks.

GO—Stop, Turn, Run At Least 5 Steps And Then Scan.

Friendly Strander Asking For Help

KNOW—Friendly People With Friendly Voices Get Children To Drop Their Guard And Then Lead Them Astray. A Statement Like This “Hi I Am A Friend Of Your Mom And Dad's. They Said You Should Come With And Help Me Find My Puppy.”

GO—Back-Up, Run And Yell, “Don't Touch Me, Stranger, Stranger” And Run Back The Same Way You Came.

END—Run To A Phone, Dial 911 & Say: “My Name Is - - - , I live At - - - , I Need Help!
Course officially ends after they say their name, entire address and to “Please Send Help!!”

### STEP 5—KNOW & GO™ CHILD SAFETY DAY

Testing day for the children to take their KNOW & GO™ Safety Test. Before starting the test give a positive reinforcement talk and then present each child with the KNOW & GO™ safety shirts which are included in each registration package. This will get the children energized before taking the course. Make sure the course is free from harmful objects. Examples of course designs are enclosed in this booklet as well as on the instructional video. As each child runs through the course make sure to change the sound tracks on the CD, so no consecutive child gets the sounds in the same order. Tracks 3, 4 & 5 listed below have the sounds mixed up in different versions so the child has to pay attention when it's his or her turn to go. (Note—explain to the children that the first sound they hear will be a bell ringing which signals them to “start” the course)

### *TRACK 3—KNOW & GO™ SAFETY COURSE—VERSION 1

BELL RINGS—START SAFETY COURSE

CAR SCREECHING TO A HALT

BROKEN GLASS

POLICE/FIRE VEHICLES IN MOTION

PANIC STRICKEN CROWD

VICIOUS DOG BARKING

SMOKE DETECTOR ALARM

TRAIN IN MOTION

FRIENDLY VOICE ASKING FOR HELP

RUN TO PHONE—DIAL 911—MY NAME IS - - - ,I LIVE AT - - - , I NEED HELP!

SAFETY COURSE ENDS.

### *TRACK 4—KNOW & GO™ CHILD SAFETY COURSE—VERSION 2

BELL RINGS≧SAFETY COURSE BEGINS

BROKEN GLASS

CAR SCREECHING TO A HALT

PANIC STRICKEN CROWD

VICIOUS DOG BARKING POLICE/FIRE VEHICLES IN MOTION

SMOKE DETECTOR ALARM

TRAIN IN MOTION

FRIENDLY VOICE ASKING FOR HELP

RUN TO THE PHONE—DIAL 911—MY NAME IS - - - , I LIVE AT - - - ,I NEED HELP!

SAFETY COURSE ENDS.

### *TRACK 5—KNOW & GO™ CHILD SAFETY COURSE—VERSION 3

BELL RINGS—SAFETY COURSE BEGINS

VICIOUS DOG BARKING

TRAIN IN MOTION

BROKEN GLASS

CAR SCREECHING TO A HALT

SMOKE DETECTOR ALARM

POLICE/FIRE VEHICLES IN MOTION

PANIC STRICKEN CROWD

FRIENDLY VOICE ASKING FOR HELP

RUN TO PHONE—DIAL 911—MY NAME IS - - - , I LIVE AT - - - . I NEED HELP!

SAFETY COURSE ENDS.

### STEP 6—KNOW & GO™ PRESENTATION

Once all children have completed the KNOW & GO™ Child Safety Course call them up one at a time with their Parent(s) or Guardian(s) and present the child with their KNOW & GO™. Certificate of Safety and present the parent/guardian with their KNOW & GO™ Parental Safety Manual. After everyone has received their certificate, take a picture to post in your school and start your KNOW & GO™ Child Safety Bulletin Board which will keep parents and children updated on the next KNOW & GO™ event.

Congratulate everyone and make sure you tell them all to:
“Be Safe!!!”

Copyright 2002. Tom Patire & CDT Training, Inc. All Rights Reserved.

1. A method of doing business as set forth in steps 1 and 2.

2. A method of sound identification with safe movement as set forth in steps 3 and 4.

3. A method of testing as set froth in step 5 and making awards as set forth in step 6.

4. A safety course as set forth in the drawings of Version I, Version II and Version III.
